(19) United States
(12) Patent Application Publication
(10) Pub. No.: US 2011/0011726 A1
(43) Pub. Date: Jan. 20, 2011

(54) DISTILLATION DEVICE

(76) Inventor: Evelyn Jost, Esslingen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/812,806

(22) PCT Filed: Jan. 12, 2009
(86) PCT No.: PCT/EP2009/000103

§ 371 Date: Jul. 14, 2010

(30) Foreign Application Priority Data
Jan. 15, 2008 (DE) 102008005861.0

(51) Int. Cl. B01D 3/42; B01D 3/02

(52) U.S. Cl. 203/71; 202/173

(57) ABSTRACT

A distillation device (1) includes at least one first distillation region (5) with at least one first gas outlet line (6) and at least one second distillation region (8) with at least one further gas outlet line (9, 9′). The distillation regions (5, 8) are connected to each other. The first distillation region (5) is formed by a first line, the second distillation region (8) by a second line, and both lines forming the distillation regions (5, 8) are connected to each other in a controllable way. The invention further relates to methods for operating such a distillation device (1).

### CROSS REFERENCE TO RELATED APPLICATIONS

This application is a United States National Phase application of International Application PCT/EP2009/000103 and claims the benefit of priority under 35 U.S.C. §119 of German Patent Application 10 2008 005 861.0 filed Jan. 15, 2008, the entire contents of which are incorporated herein by reference.

### FIELD OF THE INVENTION

The invention refers to a distillation device, as is used for distilling liquids, especially for separating liquid mixtures.

### BACKGROUND OF THE INVENTION

DE 1 773 893 A discloses a multistage distillation device with a first evaporation vessel and a distillation column arranged upon this, an adjoining condenser, and also further evaporation vessels and associated condensers, wherein the condensers are connected in each case to the subsequent evaporation vessel, and the condenser of the last vessel has a drainage pipe. In this case, all further evaporation vessels are arranged annularly around the distillation column and the pipelines which lead from the evaporation vessels to the condensers extend inside the distillation column. Each of the evaporation vessels can be electrically heated.

From WO 98/11395 A1, a heat exchanger is known, in which vapor outlets, which branch from the pipeline for the liquid which is to be processed, are provided for the vapors which are produced in the heat exchanger. These vapor outlets are brought together again at the end of the heat exchange section.

U.S. Pat. No. 4,760,742 shows a system for monitoring a petroleum flow, which includes a pipeline for the petroleum flow, from which the gases which have developed in the petroleum flow are guided via branching pipelines into a collecting pipeline for the purpose of throughflow measuring and the collecting pipeline is then directed again to the main pipe with the liquid petroleum flow, the throughflow of which is also measured.

From EP 0 344 566 A1 a distillation device is known, which has a heating device, a distillation-medium inlet, a vapor outlet, a distillation chamber between the distillation-medium inlet and the vapor outlet, and also a drain in the bottom section of the distillation chamber, which branches off from this, for the separated components. In a heating vessel, which can be filled with a heating medium which is heated up by means of the heating device, arrangement is made for a downpipe which extends from the top downwards and is connected to the distillation-medium inlet at the top, and also a riser pipe which extends from the bottom upwards to the vapor outlet. During operation, the two pipes are enveloped by the heating medium. They are also interconnected at the bottom and form the distillation chamber. The drain is arranged below the connecting point of the downpipe to the riser pipe and includes a siphon.

Known distillation devices of these types leave much to be desired. In particular, the efficiency of the distillation devices leaves a lot to be desired.

### SUMMARY OF THE INVENTION

The invention is therefore based on the object of improving a distillation device. In this case, the distillation device is especially to be able to be also used for high-boiling liquid mixtures.

According to the invention, provision is made for a distillation device which has at least one first distillation section with at least one first gas outlet pipeline, and at least one second distillation section with at least one second gas outlet pipeline, wherein the distillation sections are directly interconnected, the first distillation section being formed by means of a first pipeline and the second distillation section being formed by means of a second pipeline. In this case, the two pipelines which form the distillation sections are interconnected in a controllable manner, for example by means of a controllable valve.

In the case of the pipes, it preferably concerns pipes with a circular cross section, but pipes with a rectangular or other cross section are also possible. Inside the pipes, moreover, provision can be made for elements which influence the flow, especially ensuring a continuous mixing-through while flowing, so that in the liquid which is to be distilled a temperature profile which is as uniform as possible is established. The design of the distillation sections as pipelines enables the provision of a large heat transfer surface area as a result of a large pipeline surface. Furthermore, as a result of the flowing of the medium which is to be distilled in the pipeline a good mixing-through ensues and consequently a more uniform temperature profile in the flowing medium than in the case of a vessel with standing liquid.

By the provision of a controllable connection between the two distillation sections, a needs-based overflowing from the first distillation section into the second distillation section can take place. Furthermore, for example just using one of the two distillation sections for distillation is possible so that the device can be used for different media. In addition, the division into two distillation sections enables a separate discharging of the gases which have developed in the course of the distillation. In the case of the second distillation section, it is especially preferably a section in which a high-boiling medium can be degassed.

Between the first distillation section and the second distillation section, provision is especially preferably made for a feed pipeline for the admixing of a degassing accelerator. Since some of the liquid which is to be separated has already been removed in the first distillation section, less degassing accelerator is required. The degassing accelerator, moreover, enables improved separation of the liquid which is to be separated. Furthermore, the degree of purity of the part of the liquid which is to be separated is increased and the remaining residue minimized.

Provision is especially preferably made for two feed pipelines for degassing accelerators, wherein the first feed pipeline enters at the end of the first distillation section and the second feed pipeline enters at the start of the second distillation section.

In order to lower the temperature which is required for distillation, and therefore to reduce the necessary expenditure of energy, the distillation device can be especially preferably operated under a negative pressure.

The distillation sections are especially preferably arranged in a heatable tank. The tank in this case can define the heating chamber and can even be thermally insulated on the outside, wherein a temperature-controlled medium, such as hot water, hot oil or water vapor, can be supplied from outside. This enables a uniform temperature distribution inside the tank and therefore a uniform transfer of heat inside the tank.

Alternatively, the heat which is required for distilling can be generated by means of electric heating elements, such as especially heating coils or heating films which are wound around the pipes, or heating coils which project into the inside of the pipes, by means of tubes which serve as heating elements, for example in the form of coaxial tubes, which are wound around the pipes or arranged within them and exposed to throughflow of a heating medium, by means of a burner which is arranged directly beneath the pipes, or by means of ultrasound and/or microwaves directly in the medium which is to be distilled.

The pipes which are used in the distillation device can consist of metal, plastic, glass, porcelain or ceramic, combinations also being possible. In the case of aggressive media, the pipes can be provided, moreover, with suitable coatings. Pipes with good heat conductivity, consisting of metal, such as copper pipes or stainless steel pipes, also possibly aluminum pipes, are especially preferable.

The first distillation section is especially preferably of a coil-like design. A coil enables a compact type of construction in conjunction with a long length. In this case, the coil can also be formed by a multiplicity of straight pipe sections which by a corresponding bend or a curve are interconnected, especially welded, to form a type of coil.

The coil extends especially preferably in such a way that the Coriolis force slows down the flow, wherein the direction depends upon the site of application, being northern or southern hemisphere.

Provision is especially preferably made for a plurality of gas outlet pipelines in the first distillation section. This enables a faster and better separation of the distilled component of the liquid. In the case of a coil-like configuration of the pipeline in the first distillation section, the gas outlet pipelines can be led upwards, extending inside the coil, so that a space-saving configuration results.

In the case of a coil-like configuration of the pipeline in the first distillation section, one gas outlet pipeline per coil preferably branches off, especially preferably from the second or third coil onwards, and the last gas outlet pipeline branches off at the end of the last coil. The gas outlet pipelines which branch from the coil can simply be led upwards inside the coil. In this case, the individual gas outlet pipelines branch off from the individual coils preferably in a slightly offset manner in relation to each other.

The free flow cross section in the first distillation section is preferably larger than in the second distillation section, but it can also be smaller or the same size.

Furthermore, the inclination in the first distillation section is preferably slightly greater than in the second distillation section. The inclination of the first distillation section is especially preferably at least twice as great as the inclination of the second distillation section.

In the second distillation section, provision is preferably made for at least one gas outlet pipeline for gases which are heavier, and for at least one gas outlet pipeline for gases which are lighter.

Provision is preferably made for a common gas collecting pipeline for the gas outlet pipelines of the second distillation section, via which gas which is heavier can be discharged.

In the case of gases which are heavier, the gas collecting outlet pipeline is especially preferably arranged lower than the pipeline of the second distillation section. This enables a simple collecting and discharging of the gas.

The gas collecting outlet pipelines are preferably connected to the pipeline of the second distillation section for gases which are heavier via the gas outlet pipelines which are of curved or bent design. The curved or bent or obliquely downwards extending configuration ensures that no liquid finds its way into the gas collecting outlet pipeline, even in the case of the arrangement of the gas collecting outlet pipeline beneath the pipeline of the second distillation section.

The gas outlet pipelines which are provided in the first distillation section are preferably led individually from the tank, and the gas outlet pipelines for the gases which are heavier, which are provided in the second distillation section, are led from the tank via a common gas collecting outlet pipeline. The gas outlet pipeline for gases which are lighter can be led from the tank with the gas outlet pipelines of the first distillation section. This enables a separate further processing of the gases which are distilled in the corresponding sections, which gases may have a different purity or, especially in the case of a developing gas mixture, a different composition. However, for example a multiplicity of individual gas outlet pipelines from the two sections is also possible.

In the following text, the invention is explained in more detail, based on an exemplary embodiment with reference to the attached drawing. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a greatly schematized, and shown not true to scale, unrolled view of the distillation device according to the first exemplary embodiment;

FIG. 2 is a detailed view of a part of the distillation device in the direction of the arrow II in FIG. 1;

FIG. 3 is a perspective view of the distillation device from FIG. 1;

FIG. 4 is a view of the distillation device from FIG. 1 obliquely from below; and

FIG. 5 is a detailed view, shown partially sectioned, of a part of the distillation device from FIG. 1.

### DESCRIPTION OF THE PREFERRED EMBODIMENTS

Referring to the drawings in particular, a distillation device 1 has a tank 2 which can be heated by means of a heating facility, which is not shown in more detail, in the present case by means of water vapor which is formed in a separately formed boiler and introduced into the tank 2, and also a pipeline arrangement 3 which is arranged in the tank 2, wherein for the pipeline arrangement 3 a multiplicity of supply and disposal pipelines are led into the tank 2 or led out of it as the case may be. The tank 2 is of a pressure-tight design and is well insulated. The pipeline arrangement 3 in the present case consists of copper pipes which have good heat conductivity.

The pipeline arrangement 3 has a distillation-medium inlet pipeline 4 into the tank 2, a continuing pipeline of a coil-like design, forming a first distillation section 5, with a significantly larger diameter than the inlet pipeline 4, various first gas outlet pipelines 6 which branch from the first distillation section 5, with a diameter which corresponds to the coil-like pipeline, which are also referred to in the following text as the first group of gas outlet pipelines, a first feed pipeline 7 for a first degassing accelerator, which enters at the end of the first distillation section 5, a second distillation section 8 which then begins, which is controllably connected via a valve to the first distillation section 5 and at the start of which enters a second feed pipeline 7′ (in the drawing only indicated in FIG. 1) for a second degassing accelerator, a second group of gas outlet pipelines 9 which branch from the second distillation section 8 and lead into a common gas collecting outlet pipeline 10, and a residual-media outlet pipeline 11.

According to one variant, a multiplicity of separately formed gas outlet pipelines, which in each case are led individually from the tank, are provided at the position of a common gas collecting outlet pipeline, corresponding to the first gas outlet pipelines.

The pipeline which forms the present first distillation section 5 in the present case extends downwards in a coil-like manner with constant cross section and gentle inclination. Each coil is formed by means of six straight pipe sections which are welded to each other at the ends. One of the gas outlet pipelines 6 branches upwards from each coil from the end of the second coil onwards and are led upwards individually from the tank 2. For illustrating the gradient, a level line E, which in the erected state of the device lies in a horizontal plane, is drawn in in the unrolled view of FIG. 1. Furthermore, the lengths are not shown true to scale, so the second distillation section 8 is formed considerably shorter than the first distillation section 5. The inclination of the first distillation section 5 is identified by an angle and the inclination of the second distillation section 8 identified by an angle. In the present case, the angle is about twice as large as the angle.

Beneath the last branch of a gas outlet pipeline 6 from the first distillation section 5, with which this section ends, the pipeline is led inwards in the radial direction and approximately in the middle of the coil is bent downwards and closed off at the end. The pipeline of the first distillation section 5 has a constant, relatively large cross section to the end. In the region of the pipeline end, from oppositely disposed sides, provision is made for both the entry of the first feed pipeline 7 for the degassing accelerator and for the start of the pipeline which forms the second distillation section 8 and at the end of the second distillation section 8 becomes the residual-media outlet pipeline 11. In this case, the said valve is arranged at the start of the pipeline of the second distillation section 8 in order to control the overflow of the remaining liquid from the first distillation section 5 into the second distillation section 8. Via the second feed pipeline 7′, a further degassing accelerator can be fed in a controlled manner to the remaining liquid, wherein the first and second degassing accelerators, depending upon application case, can be identical, degassing accelerator being fed only via one of the feed pipelines 7 or 7′, or possibly even no degassing accelerator being fed. The pipeline of the second distillation section 8 as well as the feed pipelines 7, 7′ have a considerably smaller diameter than the pipeline of the first distillation section 5, wherein the diameter of the pipeline which forms the second distillation section 8 is constant up to the residual-media outlet pipeline 11.

For extending the length, the pipeline in the second distillation section 8 in the present case extends in a zigzag-like manner with a gentle inclination, wherein the bends have no influence upon the gradient of the pipeline in the present case, i.e. the inclination is essentially constant.

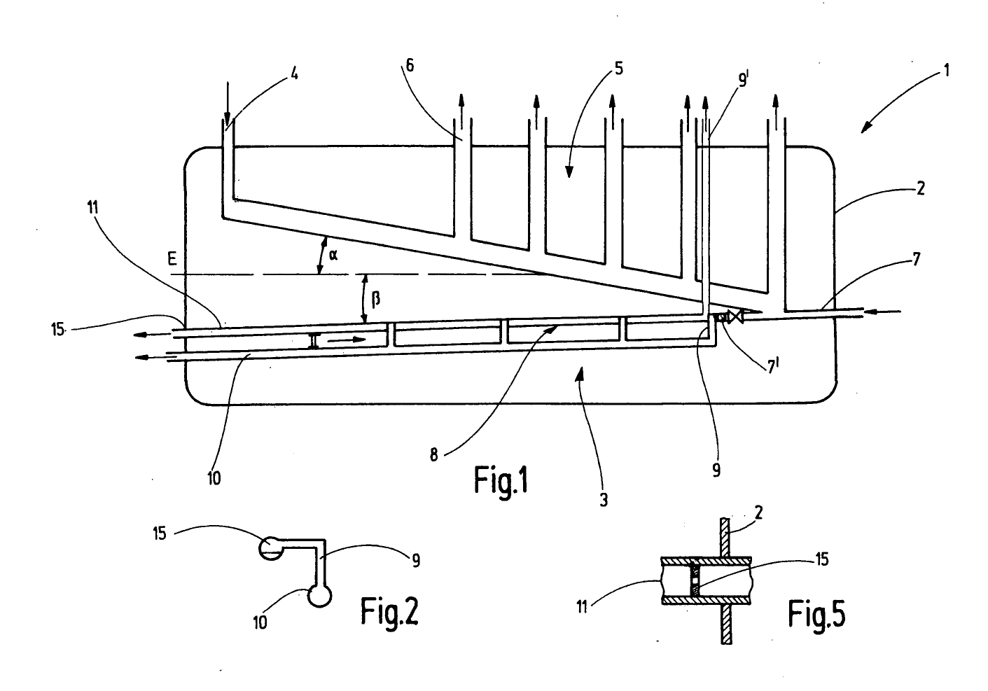

In the present case, four second gas outlet pipelines 9 branch from the second distillation section 8 and lead into the gas collecting outlet pipeline 10 which is associated with the second distillation section 8 and leads from the tank 2. The second gas outlet pipelines 9 branch from the pipeline of the second distillation section 8 parallel to the plane E and in the upper region, in the present case approximately tangentially to the highest point of the pipeline, wherein the gas outlet pipelines 9 are of a bent or curved design and in this case first of all extend horizontally and then vertically downwards and/or alternatively also extend obliquely downwards, so that from the top they lead into the gas collecting outlet pipeline 10 which is arranged lower than the second distillation section 8 (see FIG. 2). In this case, the gas outlet pipelines 9 have a smaller diameter than the pipeline of the second distillation section 8. This configuration ensures that no liquid components find their way into the gas collecting outlet pipeline 10. Furthermore, it is ensured that particularly gases which are heavier find their way into the gas collecting outlet pipeline 10.

In addition to these second gas outlet pipelines 9, provision is made in the present case for a third gas outlet pipeline 9′ via which gases which are lighter can be discharged. The third gas outlet pipeline 9′ in the present case branches off after the valve which separates the two distillation sections 5 and 8 from each other. The third gas outlet pipeline can also be arranged in the end region of the second distillation section 8. Furthermore, provision can also be made in the second distillation section 8 for a plurality of third gas outlet pipelines for discharging gases which are lighter. The one third gas outlet pipeline or, if applicable, also the plurality of gas outlet pipelines 9′, can also branch off further on the outlet side, i.e. shifted further to the left in FIG. 1.

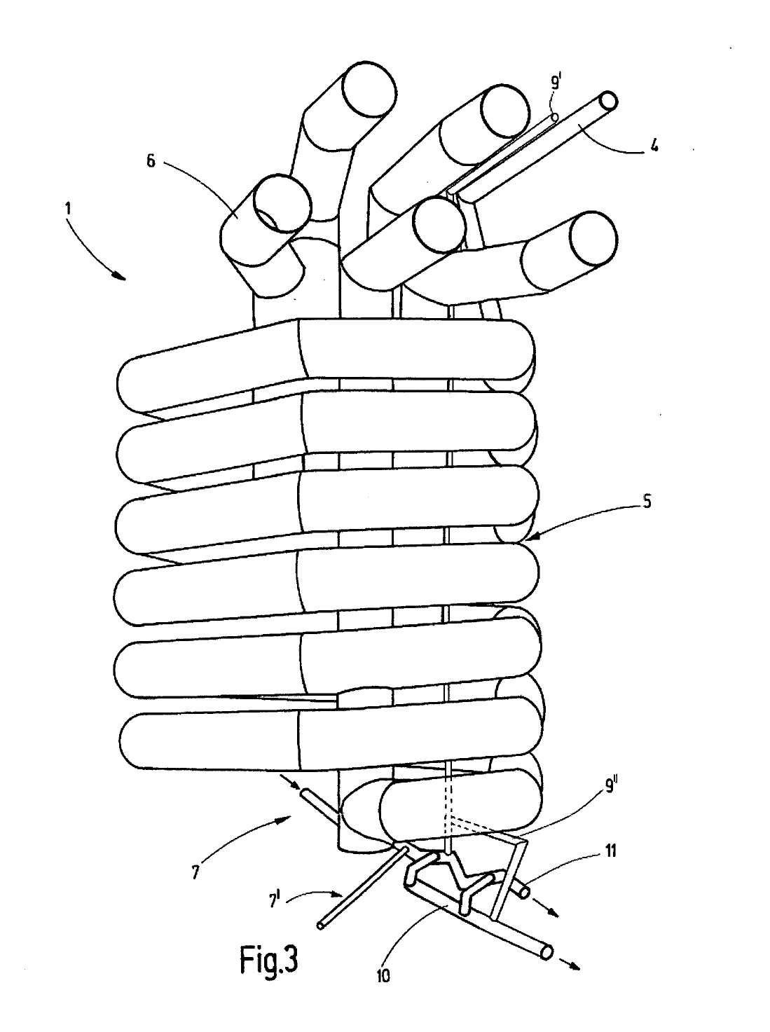

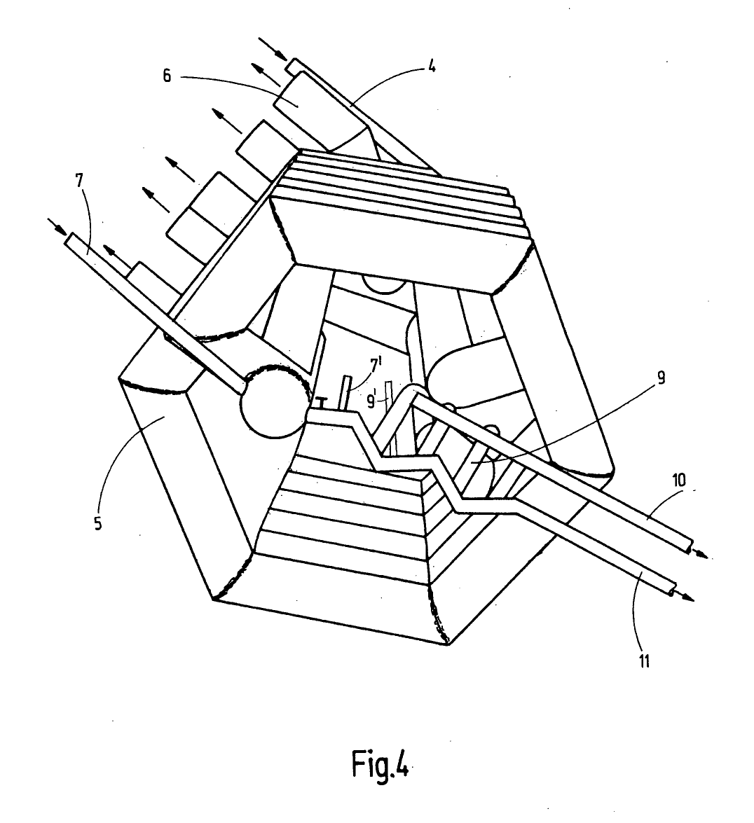

Between the third gas outlet pipeline 9′ and the collecting outlet pipeline 10 in which the gas outlet pipelines 9 are brought together, a connecting pipeline 9″ is arranged according to the present exemplary embodiment so that sinking gases from the third gas outlet pipeline 9′, for example during changes of the distillation temperature, can find their way into the collecting outlet pipeline 10. The connecting pipeline 9″ is shown only in FIG. 3 in the drawing.

According to a variant of the exemplary embodiment which is not shown in the drawing, the connecting pipeline 9″ is omitted, the rest of the construction corresponding to that described previously.

The pipeline of the second distillation section 8 merges directly into the residual-media outlet pipeline 11 which is led from the tank 2 essentially in the horizontal direction. In this case, at the end of the second distillation section 8 provision is made for a diameter reduction of the pipeline in the form of a restrictor 15 which holds back both some of the liquid residual medium and prevents degassed medium discharging in an uncontrolled manner via the residual-media outlet.

The function of the distillation device 1 under negative pressure is as follows: A currently high-boiling liquid mixture, referred to in the following text as distillation medium, is introduced into a system, in which a negative pressure prevails, for separating into two (or possibly into even more individual liquids or liquid mixtures). The distillation device 1 is part of this system. Via the distillation-medium inlet pipeline 4, the distillation medium finds its way into the heated tank 2. From the distillation-medium inlet pipeline 4, the liquid distillation medium finds its way into the coil-like first distillation section 5 and, during the slow outflow as a result of the thermal effect, supported by the negative pressure, is gradually degassed in the first distillation section, i.e. some of the liquid mixture is evaporated. The gas, which is lighter than the remaining liquid mixture, is drawn upwards from the tank 2 via the various first gas outlet pipelines 6, where the gas finds its way into downstream filters and condensers (not shown), which, however, are not part of the distillation device 1, and is further processed. Installing filters in the region of the pipeline arrangement inside the tank is possible in principle. At the end of the first distillation section 5, some of the liquid mixture is evaporated.

Via the first feed pipeline 7, a first degassing accelerator, which acts especially in the first distillation section 5 and accelerates the distillation, can be fed to the liquid mixture, moreover. Controlling the overflow into the second distillation section 8 is carried out by means of the valve which is arranged at the start of the second distillation section 8. In order to also degas as far as possible the rest of the liquid mixture which finds its way into the second distillation section 8, a degassing accelerator can again be fed via the second feed pipeline 7′ and admixed with the liquid mixture. The newly composed liquid mixture then finds its way into the second distillation section 8.

In this second distillation section, which is formed in a zigzag-like manner for extending the path length, a further part of the liquid mixture which is to be separated evaporates with the aid of the degassing accelerator which is part of the liquid mixture in the second distillation section. This gaseous part is guided via the second gas outlet pipelines 9 to the common gas collecting pipeline 10 via which the gas finds its way out of the tank 2. The remaining liquid finds its way to the outside via the residual-media outlet pipeline 11. In order to ensure a sufficient residence time of the liquid in the tank 2 and, so as not to transport any gas if possible via this outlet pipeline 11 to the outside, the outlet pipeline has a restrictor 15 at the end, i.e. in the region of the tank wall. The gas which is discharged via the outlet pipeline 11, corresponding to the gas which is discharged upwards via the first gas outlet pipelines 6, is fed to a filter and condenser and further processed. Naturally, any other treatment of the gas is also possible.

The distillation is carried out in the present case for accelerating the degassing and also the temperatures at a negative pressure which are required for it, i.e. in the pipeline arrangement together with the pipelines and devices which are associated with it a reduced pressure prevails in relation to the environment, wherein as a rule it involves a negative pressure right up to a so-called rough vacuum (1 to 300 mbar). In extreme cases, a further pressure reduction is also possible.

Alternatively, degassing at normal pressure is also possible with the previously described device.

Furthermore, degassing even without degassing accelerators can be carried out with the previously described device. If applicable, the feed pipelines 7 and/or 7′ can therefore also be omitted.

The distillation device, especially in the case of a heating device which is formed by means of electric heating elements which are arranged around the pipes, can also be operated in such a way that heating, and therefore distillation, especially of a high-boiling medium, is carried out for example only in the second distillation section 8. In this case, the medium which is to be distilled flows through the distillation-medium inlet pipeline 4, via the unheated first distillation section 5, into the second heated distillation section 8, wherein by means of one of the degassing-accelerator feed pipelines 7 or 7′ a degassing accelerator is admixed.

While specific embodiments of the invention have been described in detail to illustrate the application of the principles of the invention, it will be understood that the invention may be embodied otherwise without departing from such principles.

1. A distillation device comprising:
a first distillation section with a first section gas outlet pipeline;
a second distillation section with a further gas outlet pipeline; and
a controlled interconnection wherein the distillation sections are interconnected by the controlled interconnection, the first distillation section is formed by means of a first pipeline, the second distillation section is formed by means of a second pipeline, and the two pipelines which form the distillation sections are interconnected in a controllable manner by the controlled interconnection.

2. The distillation device as claimed in claim 1, further comprising a feed pipeline between the first distillation section and the second distillation section, the feed pipeline for the admixing of a degassing accelerator.

3. The distillation device as claimed in claim 1, further comprising a first feed pipeline that enters at the end of the first distillation section, and a second feed pipeline that enters at the start of the second distillation section, wherein the controlled interconnection comprises a valve and the first and the second distillation sections are interconnected in a controllable manner by means of the valve.

4. The distillation device as claimed in claim 1, wherein the first distillation section is formed by means of a pipeline which is of a coil-like design.

5. The distillation device as claimed in claim 4, wherein said first section gas outlet pipeline is one of a plurality of gas outlet pipelines in the first distillation section.

6. The distillation device as claimed in claim 1, wherein said further gas outlet pipeline is one of a plurality of gas outlet pipelines in the second distillation section including a gas outlet pipeline for gases which are lighter, and a gas outlet pipeline for gases which are heavier.

7. The distillation device as claimed in claim 1, wherein the distillation sections have a different inclination, wherein the inclination of the first distillation section is greater than the inclination of the second distillation section.

8. The distillation device as claimed in claim 6, further comprising: a common gas collecting outlet pipeline for the gas outlet pipelines of the second distillation section, via which gas which is heavier can be discharged, the gas collecting outlet pipeline being arranged lower than the pipeline of the second distillation section.

9. The distillation device as claimed in claim 8, wherein the gas collecting outlet pipeline is connected to the pipeline of the second distillation section via the gas outlet pipelines which are of an obliquely downwards extending, curved or bent design.

10. A method for operating a distillation device, the method comprising the steps of:
providing a first distillation section with a first section gas outlet pipeline;
providing a second distillation section with a further gas outlet pipeline;
providing a controlled interconnection wherein the distillation sections are interconnected by the controlled interconnection, the first distillation section is formed by means of a first pipeline, the second distillation section is formed by means of a second pipeline, and the two pipelines which form the distillation sections are interconnected in a controllable manner by the controlled interconnection; and
heating the distillation device and/or establishing a negative pressure such that a negative pressure prevails in the pipeline arrangement.

11. A distillation device comprising:
a first distillation section comprising a first pipeline with a gas outlet pipeline;
a second distillation section comprising a second pipeline with a further gas outlet pipeline; and
an interconnection interconnecting the first distillation section and the second distillation section for controlling fluid flow therebetween.

12. The distillation device as claimed in claim 11, further comprising a feed pipeline between the first distillation section and the second distillation section, the feed pipeline for the admixing of a degassing accelerator.

13. The distillation device as claimed in claim 11, further comprising a first feed pipeline that enters at the end of the first distillation section and a second feed pipeline that enters at the start of the second distillation section, wherein the interconnection comprises a valve and the first and the second distillation sections are interconnected in a controllable manner by means of the valve.

14. The distillation device as claimed in claim 11, wherein the first distillation section comprises one or more section forming one or more coil shape

15. The distillation device as claimed in claim 14, wherein said first section gas outlet pipeline is one of a plurality of gas outlet pipelines in the first distillation section.

16. The distillation device as claimed in claim 11, wherein said further gas outlet pipeline is one of a plurality of gas outlet pipelines in the second distillation including a gas outlet pipeline for gases which are lighter, and a gas outlet pipeline for gases which are heavier.

17. The distillation device as claimed in claim 11, wherein the distillation sections have a different inclination, wherein the inclination of the first distillation section is greater than the inclination of the second distillation section.

18. The distillation device as claimed in claim 16, further comprising: a common gas collecting outlet pipeline for the gas outlet pipelines of the second distillation section, via which gas which is heavier can be discharged, the gas collecting outlet pipeline being arranged lower than the pipeline of the second distillation section.

19. The distillation device as claimed in claim 18, wherein the gas collecting outlet pipeline is connected to the pipeline of the second distillation section via the gas outlet pipelines which are of an obliquely downwards extending, curved or bent design.
